(19) United States
(12) Patent Application Publication
(10) Pub. No.: US 2026/0135219 A1
(43) Pub. Date: May 14, 2026

(54) ENERGY STORAGE DEVICE

(71) Applicant: TOYOTA JIDOSHA KABUSHIKI KAISHA, Toyota-shi (JP)

(72) Inventor: Kenji BABA, Seto-shi (JP)

(73) Assignee: TOYOTA JIDOSHA KABUSHIKI KAISHA, Toyota-shi (JP)

(21) Appl. No.: 19/257,897

(22) Filed: Jul. 2, 2025

(30) Foreign Application Priority Data
Nov. 11, 2024 (JP) 2024-196501

(51) Int. Cl. H01M 50/24; H01M 10/613; H01M 10/6556; H01M 50/209; H01M 50/298; H01M 50/30

(52) U.S. Cl. CPC H01M 50/24; H01M 10/613; H01M 10/6556; H01M 50/209; H01M 50/298; H01M 50/30

(57) ABSTRACT

An energy storage device includes: a battery pack provided with a relief valve; a pipe that is connected to the battery pack and through which a cooling medium for cooling the battery pack flows; a wire connected to the battery pack; and a bracket that supports either or both of the pipe and the wire. The bracket is fixed to the battery pack so as to be located adjacent to the relief valve. The bracket is provided with a shielding plate located between the relief valve and either or both of the pipe and the wire that are fixed to the bracket. The shielding plate is configured to block gas discharged from the relief valve.

### CROSS-REFERENCE TO RELATED APPLICATION

This application claims priority to Japanese Patent Application No. 2024-196501 filed on Nov. 11, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Japanese Unexamined Patent Application Publication No. 2001-015090 (JP 2001-015090 A) discloses a stationary energy storage device in which a plurality of battery packs is stacked in an up-down direction and housed in a box-shaped housing.

### SUMMARY

The inventors have developed an energy storage device in which a battery pack is provided with a relief valve. A pipe through which a cooling medium for cooling the battery pack flows and a wire connected to the battery pack are provided around the battery pack. Therefore, there is a risk that the pipe and wire located near the relief valve may be damaged by high-temperature gas discharged from the relief valve.

The present disclosure has been made in view of the above circumstances, and provides an energy storage device in which a pipe or wire located near a relief valve is less likely to be damaged by gas discharged from the relief valve.

An energy storage device according to one aspect of the present disclosure includes:
a battery pack provided with a relief valve;
a pipe that is connected to the battery pack and through which a cooling medium for cooling the battery pack flows;
a wire connected to the battery pack; and
a bracket that supports either or both of the pipe and the wire.

The bracket is fixed to the battery pack so as to be located adjacent to the relief valve. The bracket is provided with a shielding plate located between the relief valve and either or both of the pipe and the wire that are fixed to the bracket. The shielding plate is configured to block gas discharged from the relief valve.

In the energy storage device of the present disclosure, the bracket that supports either or both of the pipe and the wire is fixed to the battery pack so as to be located adjacent to the relief valve. The bracket is provided with the shielding plate located between the relief valve and either or both of the pipe and the wire that are fixed to the bracket. The shielding plate is configured to block gas discharged from the relief valve. With this configuration, either or both of the pipe and wire located near the relief valve are less likely to be damaged by the gas discharged from the relief valve.

Both the pipe and the wire may be fixed to the bracket. The shielding plate may include a step portion that protrudes toward the relief valve. One of the pipe and the wire may be disposed below the step portion, and the other of the pipe and the wire may be disposed above the step portion.

The shielding plate may extend to a position below the relief valve, and may include a bottom plate that protrudes from a lower end of the shielding plate toward the relief valve.

The battery pack may include a battery module having a substantially rectangular parallelepiped shape, and a protruding portion that protrudes upward at one end of the battery module. A plurality of the battery packs may be stacked in an up-down direction and housed in a housing such that the protruding portions are alternately arranged on opposite outer sides.

The present disclosure can provide an energy storage device in which a pipe or wire located near a relief valve is less likely to be damaged by gas discharged from the relief valve.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing the overall configuration of an energy storage device according to a first embodiment;

FIG. 2 is a perspective view of a battery pack 20;

FIG. 3 is a perspective view showing a bracket 40 in the energy storage device according to the first embodiment;

FIG. 4 is an XY sectional view of the bracket 40; and

FIG. 5 is a cross-sectional view taken along line V-V in FIG. 4.

### DETAILED DESCRIPTION OF EMBODIMENTS

A specific embodiment of the present disclosure will be described in detail below with reference to the drawings. Note that the present disclosure is not limited to the following embodiment. The following description and drawings are simplified as appropriate for clarity of explanation.

### First Embodiment

### Overall Configuration of Energy Storage Device

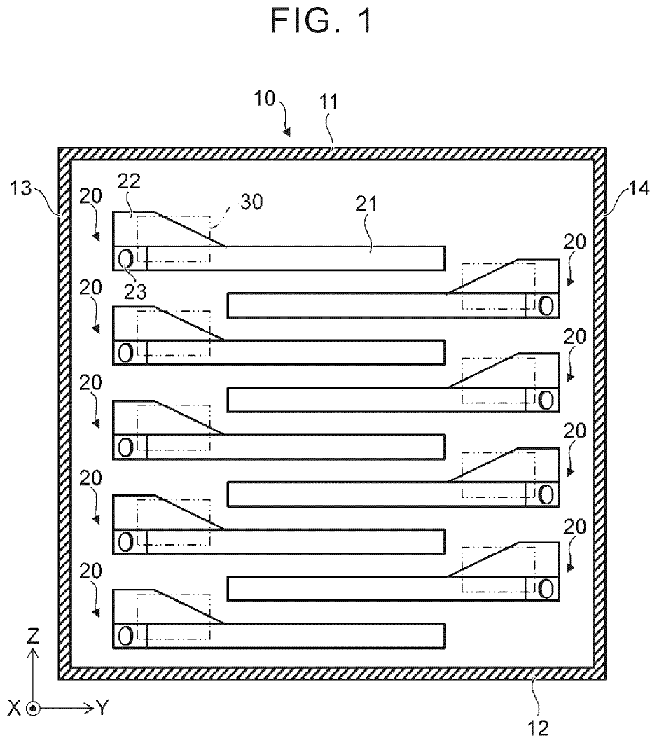

First, the overall configuration of an energy storage device according to a first embodiment will be described with reference to FIG. 1. FIG. 1 is a sectional view showing the overall configuration of the energy storage device according to the first embodiment. It should be noted that the right-handed XYZ orthogonal coordinate system shown in FIG. 1 is provided merely for convenience in explaining the positional relationship among the components. In FIG. 1, the positive Z-axis direction is generally a vertically upward direction, and an XY plane is a horizontal plane. This applies to all the drawings.

The energy storage device according to the present embodiment is, for example, an energy storage device that can be installed outdoors. As shown in FIG. 1, the energy storage device includes a plurality of battery packs 20 inside a housing 10. As shown by long dashed double-short dashed lines in FIG. 1, each battery pack 20 includes a controller 30 on the negative X-axis side. In the present embodiment, nine battery packs 20 are housed in the housing 10. However, the number of battery packs 20 is not limited as long as there are two or more battery packs 20.

As shown in FIG. 1, the housing 10 has a rectangular parallelepiped shape, that is, a box shape, and includes a top surface 11, a bottom surface 12, a front surface 13, a rear surface 14, and a pair of side surfaces, not shown, located at both ends in the X-axis direction. The housing 10 is made of a metal plate such as a steel plate.

The battery pack 20 is, for example, a lithium-ion battery, and is an in-vehicle battery pack.

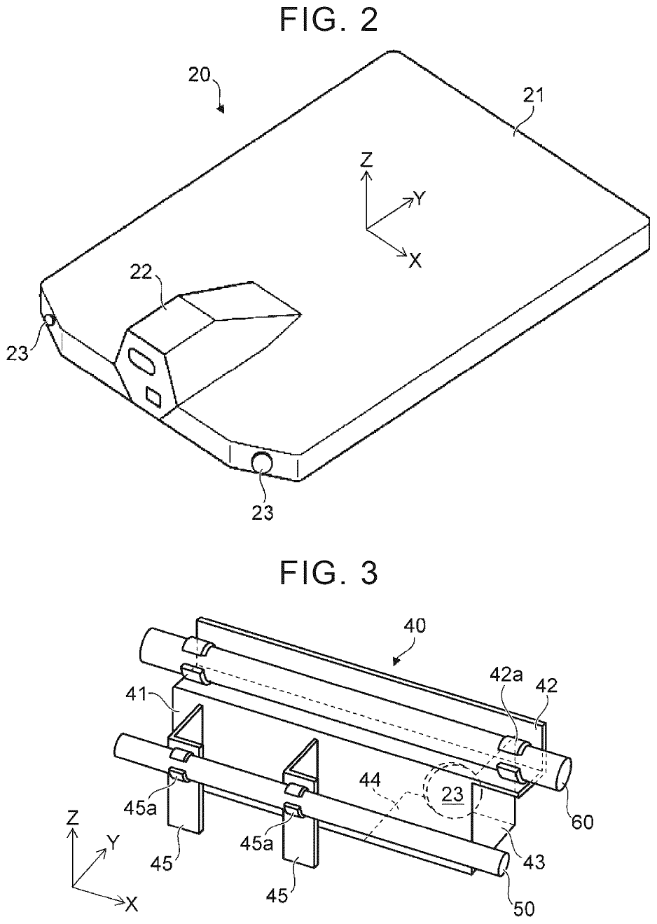

FIG. 2 is a perspective view of the battery pack 20. As shown in FIG. 2, the battery pack 20 includes a battery module 21, a protruding portion 22, and a relief valve 23. As shown in FIG. 2, the battery module 21 has a substantially rectangular parallelepiped shape. The battery module 21 is the body of the battery pack 20 and is configured by a plurality of cell stacks arranged in, for example, the X-axis direction or the Y-axis direction.

As shown in FIG. 2, the protruding portion 22 is provided at one end of the battery module 21 in the Y-axis direction so as to protrude upward. The protruding portion 22 houses electrical devices such as a relay circuit, a fuse, and a current sensor.

As shown in FIG. 1, the battery packs 20 are stacked in the up-down direction (Z-axis direction) and housed in the housing 10 such that the protruding portions 22 are staggered in the Y-axis direction. In other words, the battery packs 20 are stacked in the up-down direction such that the protruding portions 22 are alternately arranged on opposite outer sides. Therefore, the height and the center of gravity of the energy storage device are lowered, which improves the seismic resistance of the energy storage device.

The relief valve 23 discharges gas generated inside the battery module 21 to the outside of the battery module 21 in the event of an abnormality in the battery module 21. As shown in FIG. 2, a pair of the relief valves 23 is provided at both ends in the X-axis direction of the side surface on the negative Y-axis side of the battery module 21.

More specifically, one of the relief valves 23 is provided on a chamfered portion formed between the side surface on the negative Y-axis side of the battery module 21 and the side surface on the positive X-axis side of the battery module 21. The other relief valve 23 is provided on a chamfered portion formed between the side surface on the negative Y-axis side of the battery module 21 and the side surface on the negative X-axis side of the battery module 21. The number and installation positions of the relief valves 23 are not particularly limited.

### Details of Bracket 40

Although not shown in FIGS. 1 and 2, a pipe through which a cooling medium for cooling the battery pack 20 flows and a wire connected to the battery pack 20 are provided around the battery pack 20. Therefore, there is a risk that the pipe and wire located near the relief valve 23 may be damaged by high-temperature gas discharged from the relief valve 23.

In the energy storage device according to the present embodiment, a bracket that supports the pipe and the wire is provided with a shielding plate that is located between the pipe and wire and the relief valve 23 to block the gas discharged from the relief valve 23.

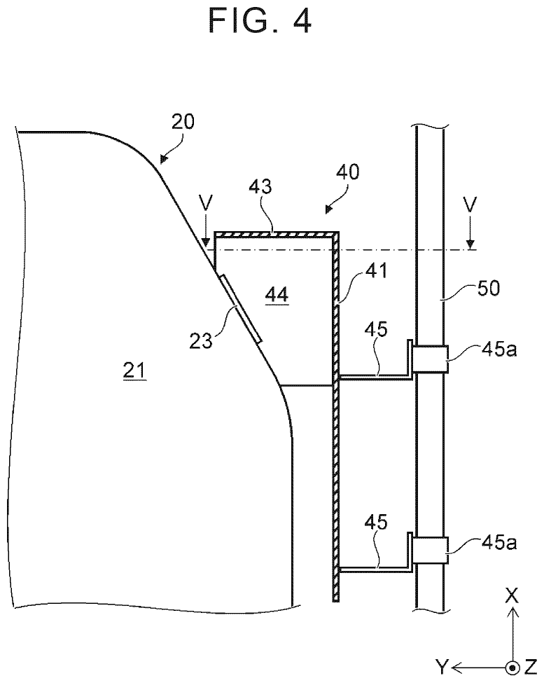

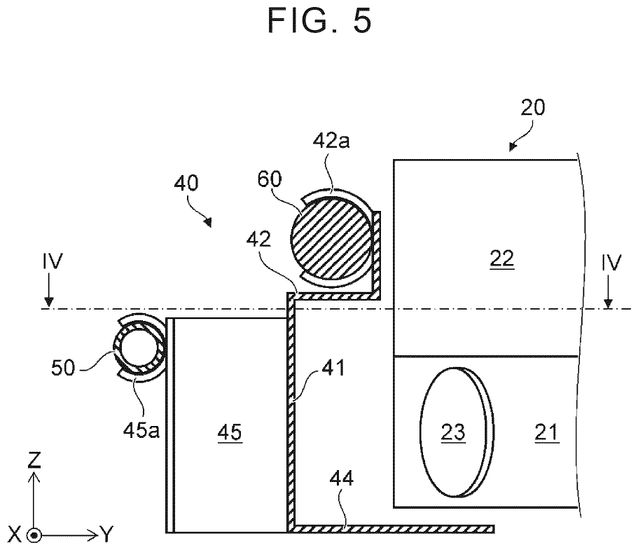

The bracket that supports the pipe and the wire will now be described in detail with reference to FIGS. 3 to 5. FIG. 3 is a perspective view showing the bracket 40 in the energy storage device according to the first embodiment. FIG. 4 is an XY sectional view of the bracket 40. FIG. 5 is a cross-sectional view taken along line V-V in FIG. 4. FIG. 4 is also a sectional view taken along line IV-IV in FIG. 5.

As shown in FIG. 3, the bracket 40 supports a pipe 50 and a wire 60. The pipe 50 is connected to the battery pack 20, and the cooling medium for cooling the battery pack 20 flows inside the pipe 50. The wire 60 is an electrical wire connected to the battery pack 20.

The pipe 50 and the wire 60 shown in FIGS. 3 to 5 extend in the X-axis direction along the side surface on the negative Y-axis side of the battery pack 20 shown in FIG. 2. The relief valve 23 shown in FIGS. 3 to 5 is the relief valve 23 provided on the chamfered portion formed between the side surface on the negative Y-axis side of the battery module 21 and the side surface on the positive X-axis side of the battery module 21.

As shown in FIGS. 3 to 5, the bracket 40 is directly or indirectly fixed to the battery pack 20 so as to be located adjacent to the relief valve 23. The bracket 40 is, but is not particularly limited to, a plate-shaped member made of, for example, a metal plate.

As shown in FIG. 3, the bracket 40 includes a main shielding plate 41, a step portion 42, a side shielding plate 43, a bottom plate 44, and a pipe support portion 45. As shown in FIG. 3, the main shielding plate 41 is a rectangular flat plate parallel to an XZ plane, and is provided between the relief valve 23 and the pipe 50. The pipe 50 is fixed to the main shielding plate 41 via the pipe support portion 45 and a pipe holding portion 45a.

As shown in FIGS. 3 and 5, the step portion 42 is a plate member that is continuous from the upper end (the end on the positive Z-axis side) of the main shielding plate 41 and that has an L-shape in YZ cross-section. More specifically, the step portion 42 includes a rectangular flat plate parallel to an XY plane and extending in the positive Y-axis direction from the upper end of the main shielding plate 41, and a rectangular flat plate parallel to an XZ plane and extending in the positive Z-axis direction from the end on the positive Y-axis side of this flat plate. As shown in FIG. 3, the step portion 42 extends further in the positive X-axis direction from the end on the positive X-axis side of the main shielding plate 41.

The wire 60 is fixed on the step portion 42 via a wire holding portion 42a. That is, the step portion 42 is a shielding plate provided between the relief valve 23 and the wire 60. In the step portion 42 shown in FIG. 3, the wire holding portion 42a that holds the wire 60 is provided at both ends of the step portion 42 in the X-axis direction. However, the present disclosure is not particularly limited to this.

As shown in FIG. 3, the side shielding plate 43 is a rectangular flat plate parallel to a YZ plane and extending in the positive Y-axis direction from the end on the positive X-axis side of the main shielding plate 41. The side shielding plate 43 is provided so as to cover the positive X-axis side of the relief valve 23. As shown in FIG. 4, the main shielding plate 41 and the side shielding plate 43 form a plate member having an L-shape in XY cross-section.

It can be said that the side shielding plate 43 is provided between the relief valve 23 and the portion of the pipe 50 that protrudes beyond the end on the positive X-axis side of the main shielding plate 41, as shown in FIG. 4. It can also be said that the side shielding plate 43 is provided between the relief valve 23 and the portion of the wire 60 that protrudes beyond the end on the positive X-axis side of the step portion 42, as shown in FIG. 3.

As shown in FIG. 3, the bottom plate 44 is a rectangular plate member parallel to an XY plane and extending in the positive Y-axis direction from the lower end portion on the positive X-axis side (the end portion on the negative Z-axis side) of the main shielding plate 41. It can also be said that the bottom plate 44 is a plate member extending in the negative X-axis direction from the lower end of the side shielding plate 43.

As shown in FIG. 5, the main shielding plate 41 extends to a position below the relief valve 23, and the bottom plate 44 protrudes from the lower end of the main shielding plate 41 toward the relief valve 23. That is, the bottom plate 44 is a shielding plate provided so as to cover the lower side of the relief valve 23.

As shown in FIGS. 3 to 5, the pipe support portion 45 supports the pipe 50. The pipe support portion 45 is provided so as to protrude in the negative Y-axis direction from the main surface of the main shielding plate 41. Therefore, the pipe support portion 45 supports the pipe 50 such that the pipe 50 is located away from the main shielding plate 41, that is, such that the pipe 50 is located away from the relief valve 23.

The pipe support portion 45 shown in FIGS. 3 to 5 is a plate member having an L-shape in XY cross-section. The pipe support portion 45 includes a rectangular flat plate parallel to a YZ plane and standing perpendicularly from the main surface of the main shielding plate 41, and a rectangular flat plate parallel to an XZ plane and extending in the positive X-axis direction from the end on the negative Y-axis side of this flat plate. The pipe 50 is fixed via the pipe holding portion 45a to the flat plate of the pipe support portion 45 that is parallel to an XZ plane.

As described above, in the energy storage device according to the present embodiment, the bracket 40 that supports the pipe 50 and the wire 60 is provided with a shielding plate (for example, the main shielding plate 41 and the step portion 42) that is located between the pipe 50 and wire 60 and the relief valve 23 to block the gas discharged from the relief valve 23. With this configuration, the pipe 50 and wire 60 located near the relief valve 23 are less likely to be damaged by the gas discharged from the relief valve 23.

The bracket 40 shown in FIGS. 3 to 5 is merely an example, and may have any shape as long as it is located between the pipe 50 and wire 60 and the relief valve 23 and includes a shielding plate that blocks the gas discharged from the relief valve 23. The bracket 40 is not particularly limited as long as it supports either or both of the pipe 50 and the wire 60.

The present disclosure is not limited to the above embodiment, and can be modified as appropriate without departing from the spirit and scope of the present disclosure.

What is claimed is:

1. An energy storage device comprising:
a battery pack provided with a relief valve;
a pipe through which a cooling medium for cooling the battery pack flows, the pipe being connected to the battery pack;
a wire connected to the battery pack; and
a bracket that supports either or both of the pipe and the wire, wherein:
the bracket is fixed to the battery pack so as to be located adjacent to the relief valve; and
the bracket is provided with a shielding plate located between the relief valve and either or both of the pipe and the wire that are fixed to the bracket, the shielding plate being configured to block gas discharged from the relief valve.

2. The energy storage device according to claim 1, wherein:
both the pipe and the wire are fixed to the bracket;
the shielding plate includes a step portion that protrudes toward the relief valve; and
one of the pipe and the wire is disposed below the step portion, and the other of the pipe and the wire is disposed above the step portion.

3. The energy storage device according to claim 2, wherein the shielding plate extends to a position below the relief valve, and includes a bottom plate that protrudes from a lower end of the shielding plate toward the relief valve.

4. The energy storage device according to claim 1, wherein:
the battery pack includes a battery module having a substantially rectangular parallelepiped shape, and a protruding portion that protrudes upward at one end of the battery module; and
a plurality of the battery packs is stacked in an up-down direction and housed in a housing such that the protruding portions are alternately arranged on opposite outer sides.
